(19) United States
(12) Patent Application Publication
(10) Pub. No.: US 2016/0268044 A1
(43) Pub. Date: Sep. 15, 2016

(54) MULTILAYER CERAMIC COMPONENT

(71) Applicant: SAMSUNG ELECTRO-MECHANICS CO., LTD., Suwon-Si (KR)

(72) Inventors: Hyun Hee GU, Suwon-Si (KR); Myung Jun PARK, Suwon-Si (KR); Byoung Jin CHUN, Suwon-Si (KR); Young Sook LEE, Suwon-Si (KR); Hye Jin JEONG, Suwon-Si (KR); Hye Young CHOI, Suwon-Si (KR); Chung Yeol LEE, Suwon-Si (KR)

(21) Appl. No.: 14/862,106

(22) Filed: Sep. 22, 2015

(30) Foreign Application Priority Data
Mar. 13, 2015 (KR) 10-2015-0035023

(51) Int. Cl. H01G 4/12; H01G 4/012; H01G 4/236; H01G 4/30

(52) U.S. Cl. CPC H01G 4/12; H01G 4/30; H01G 4/012; H01G 4/236

(57) ABSTRACT

A multilayer ceramic component is provided. The multilayer ceramic component includes a ceramic body including a plurality of ceramic laminates, each including a plurality of dielectric layers and a plurality of internal electrodes and having first and second surfaces opposing each other in a first direction, third and fourth surfaces opposing each other in a second direction, and fifth and sixth surfaces opposing each other in a third direction, and a plurality of external electrodes including base electrode layers disposed on outer surfaces of the ceramic body and respectively connected to the internal electrodes of the ceramic laminates, and resin electrode layers disposed on the base electrode layers to expose at least portions of end portions of the base electrode layers, respectively.

### CROSS-REFERENCE TO RELATED APPLICATION

This application claims the priority and benefit of Korean Patent Application No. 10-2015-0035023 filed on Mar. 13, 2015, with the Korean Intellectual Property Office, the disclosure of which is incorporated herein by reference.

### BACKGROUND

The present disclosure relates to a multilayer ceramic component.

Electronic components using a ceramic material, such as capacitors, inductors, piezoelectric elements, varistors, thermistors, and the like, include a ceramic body formed of a ceramic material, internal electrodes formed in the ceramic body, and external electrodes installed on surfaces of the ceramic body to be connected to the internal electrodes.

Among electronic components, a multilayer ceramic capacitor (MLCC) has been favorably used as a bypass capacitor disposed within a power circuit of large scale integration (LSI). In order for the multilayer ceramic capacitor to serve as the bypass capacitor, the multilayer ceramic capacitor is required to effectively remove high frequency noise. This demand has further increased in accordance with a trend toward an increase in frequency of an electronic apparatus. The multilayer ceramic capacitor used as the bypass capacitor may be electrically connected onto mounting pads on a circuit board through soldering, and the mounting pads may be connected to other external circuits through a wiring pattern on the circuit board or conductive vias.

Meanwhile, a multilayer ceramic capacitor has equivalent series resistance (ESR) and equivalent series inductance (ESL) components in addition to a capacitance component. These ESR and ESL components hinder a function of the bypass capacitor. Therefore, a multilayer ceramic capacitor having a low ESR has been demanded. In addition, in accordance with recent miniaturization of electronic products, it has been demanded that a multilayer ceramic capacitor used in electronic products be microminiaturized and have ultra high capacitance.

### SUMMARY

An aspect of the present disclosure may provide a multilayer ceramic component having relatively low equivalent series resistance (ESR), excellent durability and reliability, being microminiaturized, and having ultra high capacitance, and a method of manufacturing the same.

According to an aspect of the present disclosure, a multilayer ceramic component may include a ceramic body including a plurality of ceramic laminates, each including a plurality of dielectric layers and a plurality of internal electrodes and having first and second surfaces opposing each other in a first direction, third and fourth surfaces opposing each other in a second direction, and fifth and sixth surfaces opposing each other in a third direction, and a plurality of external electrodes including base electrode layers disposed on outer surfaces of the ceramic body and respectively connected to the internal electrodes of the ceramic laminates, and resin electrode layers disposed on the base electrode layers to expose at least portions of end portions of the base electrode layers, respectively.

According to another aspect of the present disclosure, a multilayer ceramic component may include a ceramic body including a plurality of ceramic laminates, each including a plurality of dielectric layers and a plurality of internal electrodes, and a plurality of external electrodes including base electrode layers disposed on outer surfaces of the ceramic body and respectively connected to the internal electrodes of the ceramic laminates, resin electrode layers disposed on the base electrode layers, and plating layers disposed on the resin electrode layers, respectively. Here, the base electrode layers may have end portions exposed from the resin electrode layers and directly contact the plating layers through the end portions.

According to another aspect of the present disclosure, a multilayer ceramic component may include a ceramic body having first and second surfaces opposing each other, third and fourth surfaces opposing each other, and fifth and sixth surfaces opposing each other, and including a plurality of ceramic laminates, each ceramic laminate including a plurality of dielectric layers and a plurality of internal electrodes alternatively exposed to the third and fourth surfaces of the ceramic body, and a plurality of external electrodes including base electrode layers including end portions disposed on the fifth and sixth surfaces of the ceramic body and extending between the end portions to electrically connect to the internal electrodes exposed to the third and fourth surfaces of the ceramic body, respectively, and resin electrode layers disposed on the base electrode layers to expose portions of the end portions of the base electrode layers, respectively.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view illustrating a multilayer ceramic component according to an exemplary embodiment in the present disclosure;

FIGS. 2A through 2D are various plan views illustrating a fifth or sixth surface of the multilayer ceramic component of FIG. 1;

FIGS. 3A through 3D are cross-sectional views of the multilayer ceramic component of FIG. 1 in a first-second direction;

FIGS. 4A through 4C are, respectively, cross-sectional views of the multilayer ceramic component of FIG. 1 taken along line A-A′, line B-B′, and line C-C′;

FIG. 5 is a cross-sectional view of the multilayer ceramic component taken along line A-A′ in a case in which external electrodes further include plating layers in FIG. 4A;

FIG. 6 is a perspective view illustrating a ceramic body and internal electrodes of a multilayer ceramic component according to another exemplary embodiment in the present disclosure;

FIG. 7 is an exploded perspective view illustrating a multilayer structure of ceramic laminates of the multilayer ceramic component according to another exemplary embodiment in the present disclosure;

FIG. 8 is a schematic perspective view illustrating a case in which external electrodes are added to the multilayer ceramic component of FIG. 1;

FIG. 9 is a flow chart schematically illustrating a method of manufacturing a multilayer ceramic component according to an exemplary embodiment in the present disclosure; and

FIG. 10 is a perspective view schematically illustrating a circuit board having a multilayer ceramic component according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Multilayer Ceramic Component

Multilayer ceramic components, according to various exemplary embodiments, may include a ceramic body including a plurality of ceramic laminates and a plurality of external electrodes. Each of the ceramic laminates may include dielectric layers and internal electrodes, and each of the external electrodes may include a base electrode layer connected to the internal electrodes of the ceramic laminates and a resin electrode layer disposed on the base electrode layer. Since the plurality of ceramic laminates are included in the ceramic body, it may be easy to allow the electronic component to be microminiaturized and have ultra high capacitance.

According to various exemplary embodiments, the resin electrode layer is not disposed on the base electrode layer to completely cover the entire base electrode layer, but may be disposed on the base electrode layer to expose at least portions of end portions of the base electrode layer. The end portions of the base electrode layer may be exposed from the resin electrode layer, whereby external current may flow to the internal electrodes without passing through the resin electrode layer having conductivity lower than that of the base electrode layer. Therefore, equivalent series resistance (ESR) of the multilayer ceramic component may be reduced. In addition, a remaining region of the base electrode layer may be covered with the resin electrode layer, whereby moisture resistance, reliability, and warpage resistance of the multilayer ceramic component may be improved.

According to various exemplary embodiments, the external electrodes may further include a plating layer disposed on the resin electrode layer. The plating layer may be disposed to be directly connected to the base electrode layer exposed from the resin electrode layer. The plating layer may be directly connected to the base electrode layer, whereby ESR of the multilayer ceramic component may be substantially reduced due to the above-mentioned reason.

Hereinafter, multilayer ceramic components, according to various exemplary embodiments, will be described in more detail with reference to the accompanying drawings.

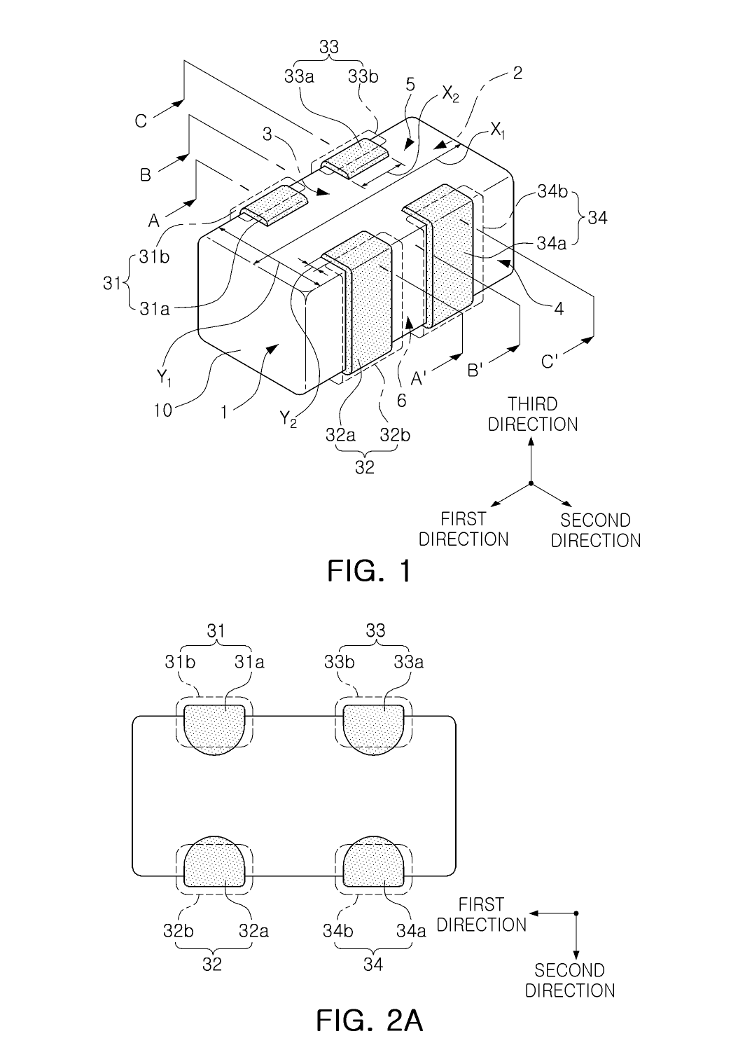

FIG. 1 is a schematic perspective view illustrating a multilayer ceramic component according to an exemplary embodiment.

Referring to FIG. 1, a multilayer ceramic component, according to an exemplary embodiment, may include a ceramic body 10 including a plurality of ceramic laminates (not illustrated) and a plurality of external electrodes 31 to 34.

In an exemplary embodiment, a shape of the ceramic body 10 is not particularly limited, but may be hexahedral, as illustrated in FIG. 1. Although the ceramic body 10 does not have a hexahedral shape having perfectly straight lines due to sintering shrinkage of ceramic powders at the time when the multilayer ceramic component is sintered, it may have a substantially hexahedral shape.

In an exemplary embodiment, the ceramic body 10 may have first and second surfaces 1 and 2 opposing each other in a first direction, third and fourth surfaces 3 and 4 opposing each other in a second direction and connecting the first and second surfaces to each other, and fifth and sixth surfaces 5 and 6 opposing each other in a third direction and connecting the first and second surfaces to each other.

In an exemplary embodiment, first and second external electrodes 31 and 32 may serve as a pair of external electrodes to which different voltages are applied, respectively, and third and fourth external electrodes 33 and 34 may serve as a pair of external electrodes to which different voltages are applied, respectively.

In an exemplary embodiment, the first to fourth external electrodes 31 to 34 may include base electrode layers 31a to 34a directly connected to internal electrodes and resin electrode layers 31b to 34b disposed on the base electrode layers, respectively. The resin electrode layers 31b to 34b may not directly contact any internal electrodes

In an exemplary embodiment, the resin electrode layers 31b to 34b may expose at least portions of end portions of the base electrode layers 31a to 34a, respectively. The end portions of the base electrode layers 31a to 34a may be exposed, whereby ESR of the multilayer ceramic component may be decreased, and the remaining regions of the base electrode layers 31a to 34a may be covered with the resin electrode layers 31b to 34b, respectively, whereby moisture resistance, reliability, and warpage resistance of the multilayer ceramic component may be improved. Meanwhile, in the present disclosure, the end portion refers to a region opposed to a central region.

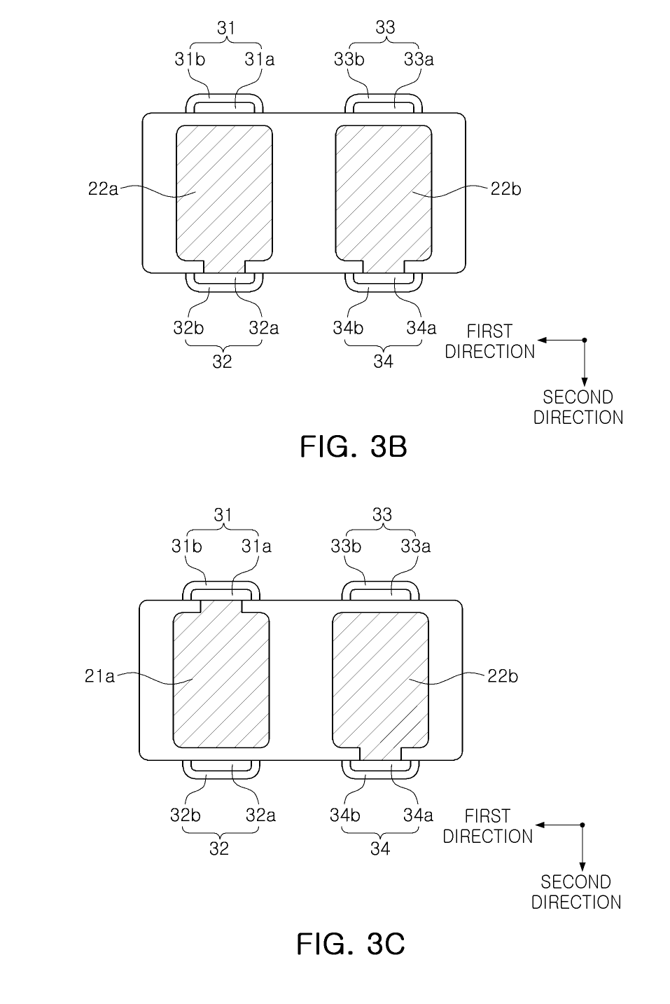

In an exemplary embodiment, the base electrode layers 31a to 34a may include main parts 31′ to 34′ (see FIGS. 4A and 4C) formed on the third and fourth surfaces 3 and 4 of the ceramic body in the second direction thereof and directly connected to the internal electrodes and extended parts 31″ to 34″ (see FIGS. 4A and 4C) extended from the main parts and formed on the fifth and sixth surfaces 5 and 6 of the ceramic body in the third direction thereof, respectively. The resin electrode layers 31b to 34b may be disposed on the base electrode layers 31a to 34a to expose portions of the extended parts 31″ to 34″ of the base electrode layers. The resin electrode layers 31b to 34b may be disposed on the base electrode layers 31a to 34a to cover the entirety of the main parts 31′ to 34′ of the base electrode layers 31a to 34a.

In an exemplary embodiment, a length X₂ of each of the exposed end portions of the base electrode layers 31a to 34a in the first direction of the ceramic body may be 1 μm or more. In a case in which the length X₂ of each of the exposed end portions of the base electrode layers 31a to 34a in the first direction of the ceramic body is less than 1 μm, an ESR improvement effect may not be substantially present. However, in a case in which a distance between the base electrode layers 31a to 34a adjacent to each other in the first direction of the ceramic body is less than 10 μm, electrodes may contact each other and be short circuited due to scattering at the time when an electrode material is applied. Accordingly, a length X₁ from the first surface 1 of the ceramic body to the second surface 2 thereof in the first direction of the ceramic body, the length X₂ of each of the exposed end portions of the base electrode layers 31a to 34a in the first direction of the ceramic body, and the number N of external electrodes 31 and 33 or 32 and 34 of which the exposed end portions are directed toward the same direction in the first direction of the ceramic body may satisfy X₂≦(X₁/N)−5 μm.

In an exemplary embodiment, a length Y₂ of each of the exposed end portions of the base electrode layers 31a to 34a in the second direction of the ceramic body may be 1 μm or more. In a case in which the length Y₂ of each of the exposed end portions of the base electrode layers 31a to 34a in the second direction of the ceramic body is less than 1 μm, a problem may occur in density or electrode connectivity, and thus an ESR improvement effect may not be significant. However, in a case in which a distance between the base electrode layers 31a to 34a facing each other in the second direction of the ceramic body is less than 10 μm, the electrodes may contact each other and be short circuited due to scattering at the time when an electrode material is applied. Accordingly, a length Y₁ from the third surface 3 of the ceramic body to the fourth surface 4 thereof in the second direction of the ceramic body and the length Y₂ of each of the exposed end portions of the base electrode layers 31a to 34a in the second direction of the ceramic body may satisfy Y₂≦(Y₁/2)−5 μm.

In an exemplary embodiment, the base electrode layers 31a to 34a may be firing-type electrodes formed by firing paste containing a conductive metal. The base electrode layers 31a to 34a may be formed by firing paste containing glass and copper as the conductive metal.

In an exemplary embodiment in the present disclosure, the resin electrode layers 31b to 34b may contain a thermosetting polymer, such as an epoxy resin, an acryl resin, or a mixture thereof, but are not limited thereto. The resin electrode layers 31b to 34b may contain metal powders as conductive particles, such as silver (Ag) powders, copper (Cu) powders, nickel (Ni) powders, or the like.

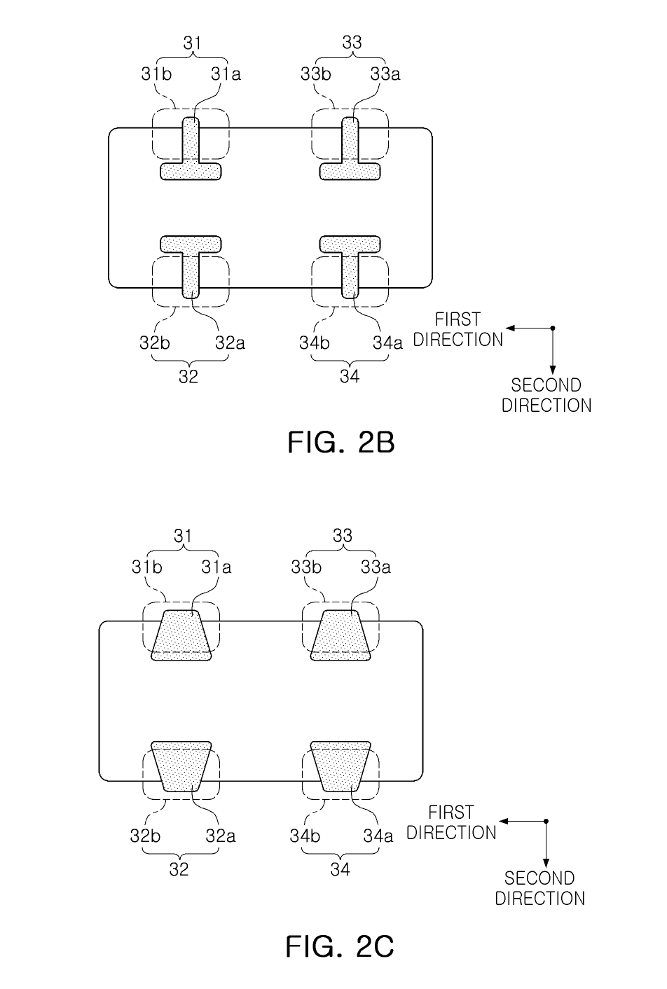

FIGS. 2A through 2D are various plan views illustrating a fifth or sixth surface of the multilayer ceramic component of FIG. 1.

In an exemplary embodiment, shapes of the end portions of the base electrode layers 31a to 34a are not particularly limited, but may be, for example, a round shape as illustrated in FIG. 2A, a T shape as illustrated in FIG. 2B, a trapezoidal shape as illustrated in FIG. 2C, or a combination thereof.

In an exemplary embodiment, exposed regions of the end portions of the base electrode layers 31a to 34a are not particularly limited, but may be, for example, only upper regions of the base electrode layers 31a to 34a as illustrated in FIGS. 2A to 2C, both of upper regions and side regions of the base electrode layers 31a to 34a as illustrated in FIG. 2D, or an a combination thereof.

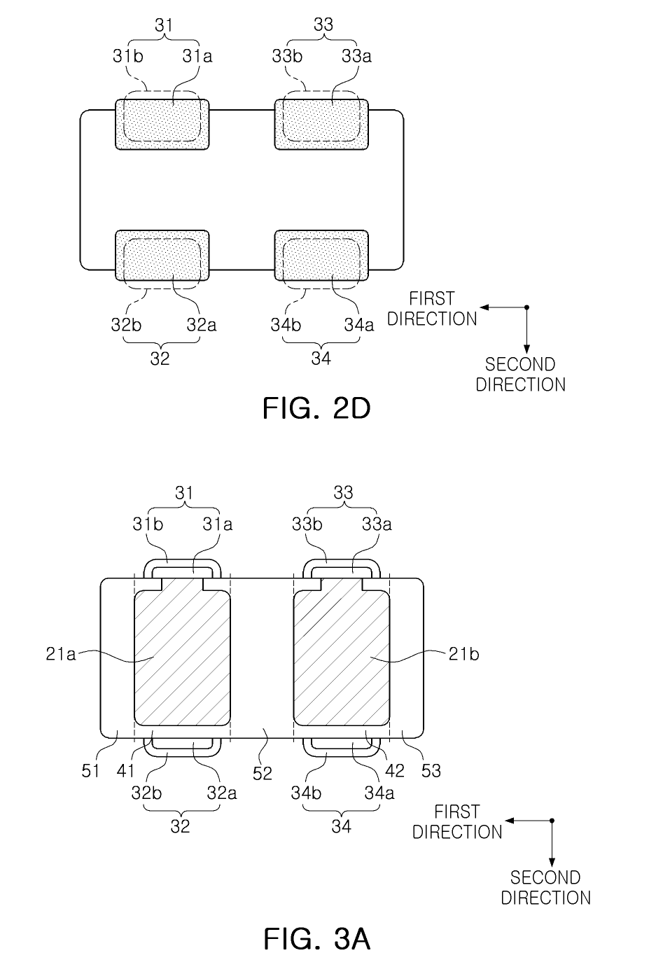

FIGS. 3A through 3D are cross-sectional views of the multilayer ceramic component of FIG. 1 in a first-second direction; and FIGS. 4A through 4C are, respectively, cross-sectional views of the multilayer ceramic component of FIG. 1 taken along line A-A′, line B-B′, and line C-C′.

In an exemplary embodiment, the third direction of the ceramic body 10 refers to a direction in which dielectric layers 11 and a plurality of internal electrodes 21a, 22a, 21b, and 22b are stacked in the ceramic body.

Referring to FIGS. 3A through 4C, each of the ceramic laminates 41 and 42 may include a plurality of dielectric layers 11. Here, first to fourth internal electrodes 21a, 22a, 21b, and 22b may be formed on dielectric layers of the ceramic laminates 41 and 42, respectively.

In an exemplary embodiment in the present disclosure, the ceramic laminates 41 and 42 may be disposed to be spaced apart from each other by a predetermined interval in the first direction of the ceramic body, and may include the internal electrodes 21a, 22a, 21b, and 22b alternately exposed through the third and fourth surfaces 3 and 4 of the ceramic body in the second direction thereof with respective dielectric layers 11 interposed therebetween.

In an exemplary embodiment, each of the ceramic laminates 41 and 42 may include an active layer, which contributes to forming capacitance, and upper and lower cover layers formed as upper and lower margin parts on upper and lower surfaces of the active layers, respectively. The active layers may include the dielectric layers 11 and the internal electrodes 21a, 22a, 21b, and 22b. The plurality of first to fourth internal electrodes 21a, 22a, 21b, and 22b may be alternately formed with each of the dielectric layers 11 interposed therebetween, respectively.

In an exemplary embodiment, the upper and lower cover layers may be formed of the same material as that of the dielectric layers 11 and have the same configuration as that of the dielectric layers 11 except that they do not include the internal electrodes. The upper and lower cover layers may be formed by stacking a single dielectric layer or two or more dielectric layers on upper and lower surfaces of the active layer, respectively, in the third direction, and may serve to prevent damage to the internal electrodes due to physical or chemical stress.

In an exemplary embodiment, a buffer part 52 in which the internal electrodes are not formed may be interposed between the ceramic laminates 41 and 42, and cover parts 51 and 53 may be disposed at opposite end portions of the ceramic body in the first direction thereof, respectively. The buffer part 52 and the cover parts 51 and 53 may be formed of the same material as that of the dielectric layers 11 and have the same configuration as that of the dielectric layers 11 except that they do not include the internal electrodes.

In an exemplary embodiment, as illustrated in FIGS. 3A and 3B, the first and third internal electrodes 21a and 21b may be disposed on the same dielectric layers, and the second and fourth internal electrodes 22a and 22b may be disposed on the same dielectric layers. Here, the dielectric layers on which the first and third internal electrodes 21a and 21b are disposed and the dielectric layers on which the second and fourth internal electrodes 22a and 22b are disposed may be alternately stacked.

Alternatively, as illustrated in FIGS. 3C and 3D, the first and fourth internal electrodes 21a and 22b may be disposed on the same dielectric layers, and the second and third internal electrodes 22a and 21b may be disposed on the same dielectric layers. Here, the dielectric layers on which the first and fourth internal electrodes 21a and 22b are disposed and the dielectric layers on which the second and third internal electrodes 22a and 21b are disposed may be alternately stacked.

In an exemplary embodiment, the first and second internal electrodes 21a and 22a may overlap each other to form capacitance, and the first and second external electrodes 31 and 32 may be connected to the first and second internal electrodes 21a and 22a, respectively. Likewise, the third and fourth internal electrodes 21b and 22b may overlap each other to form capacitance, and the third and fourth external electrodes 33 and 34 may be connected to the third and fourth internal electrodes 21b and 22b, respectively. Voltages having opposite polarities may be applied to the first and second internal electrodes 21a and 22a, respectively, and voltages having opposite polarities may be applied to the third and fourth internal electrodes 21b and 22b, respectively.

In an exemplary embodiment, the dielectric layers 11 may be in a sintered state, and adjacent dielectric layers may be integrated with each other so that boundaries therebetween are not readily apparent.

In an exemplary embodiment, the dielectric layers 11 may include high-k ceramic powders, such as barium titanate (BaTiO₃) based powders or strontium titanate (SrTiO₃) based powders. However, a material of the dielectric layers 11 is not limited thereto.

In an exemplary embodiment, the first to fourth internal electrodes 21a, 22a, 21b, and 22b may be formed by printing conductive paste containing a conductive metal at a predetermined thickness on the dielectric layers 11, and may be electrically insulated from each other by the dielectric layers 11 disposed therebetween. The conductive metal may be nickel (Ni), copper (Cu), palladium (Pd), or an alloy thereof. However, the conductive metal is not limited thereto.

In an exemplary embodiment, the first to fourth internal electrodes 21a, 22a, 21b, and 22b may be electrically connected, respectively, to the first to fourth external electrodes 31 to 34 through portions thereof exposed to the third and fourth surfaces 3 and 4 of the ceramic body 10. Therefore, when voltages are applied to the first to fourth external electrodes 31 to 34, electric charges may be accumulated between the first to fourth internal electrodes 21a, 22a, 21b, and 22b facing each other. In this case, capacitance of the multilayer ceramic component 10 may be in proportion to an area of a region in which the first to fourth internal electrodes 21a, 22a, 21b, and 22b overlap each other.

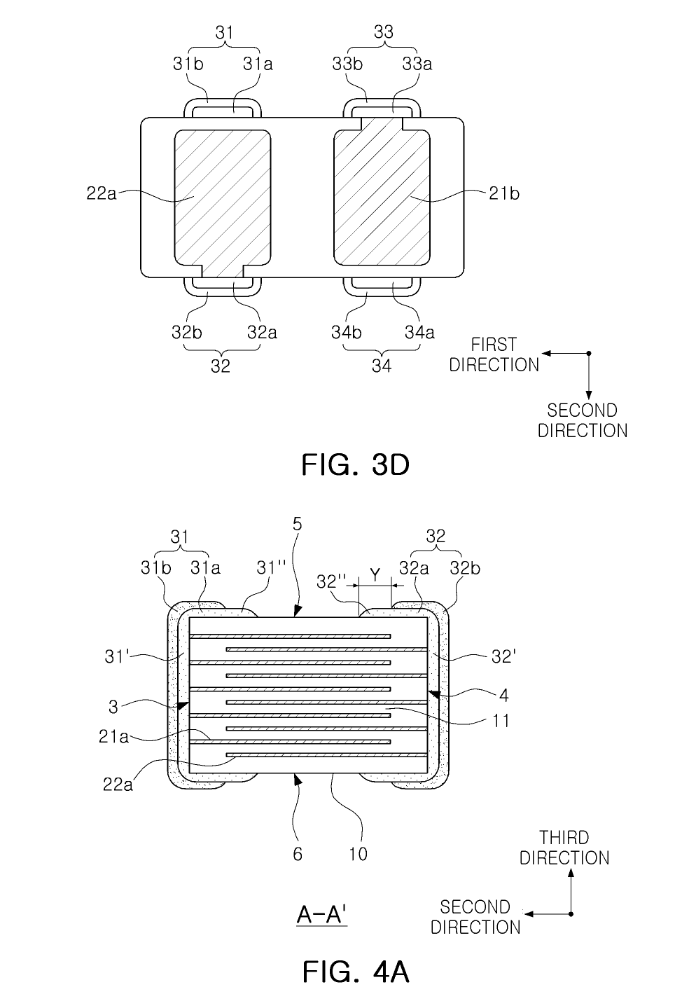

FIG. 5 is a cross-sectional view of the multilayer ceramic component taken along line A-A′ in a case in which external electrodes further include plating layers in FIG. 4A.

Referring to FIG. 5, plating layers 31c and 32c may be formed on the resin electrode layers 31b and 32b, respectively, and may be disposed to directly contact, respectively, the base electrode layers 31a and 32a exposed from the resin electrode layers. Therefore, the base electrode layers and the plating layers may be electrically connected directly to each other.

In an exemplary embodiment in the present disclosure, the plating layers may be disposed to cover the end portions of the base electrode layers exposed from the resin electrode layers, respectively. In a case in which the external electrodes further include the plating layers, current may flow through a path of the internal electrodes to the base electrode layers to the plating layers to outward, and an increase in ESR may be prevented by the resin electrode layers. In a case in which the end portions of the base electrode layers are exposed from the resin electrode layers, the ESR of the multilayer ceramic component may be decreased, and thus a degree of freedom for a content of conductive powder in the resin electrode layers may be increased. For example, in a case in which impact absorbing efficiency of the multilayer ceramic component is required to be further improved, content of the base resin in the resin electrode layers may be increased, and content of the conductive powder in the resin electrode layers may be decreased.

In an exemplary embodiment, the plating layers may contain nickel (Ni) or tin (Sn), but are not limited thereto. The plating layers may be formed as dual layers, and may include nickel (Ni) plating layers formed on the resin electrode layers and tin (Sn) plating layers formed on the nickel (Ni) plating layers, but are not limited thereto.

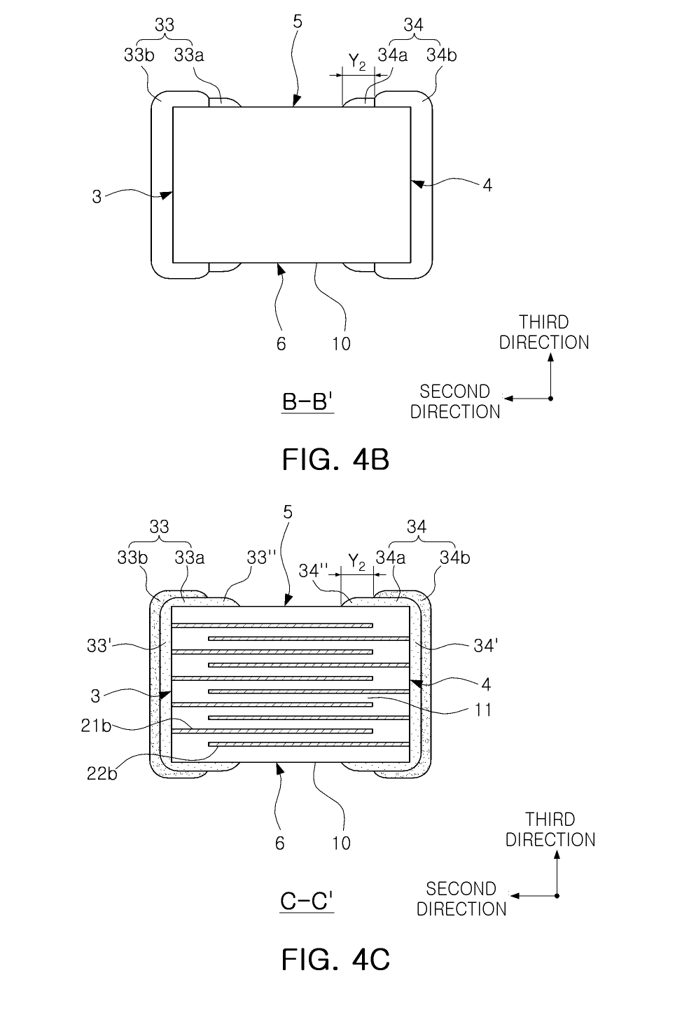

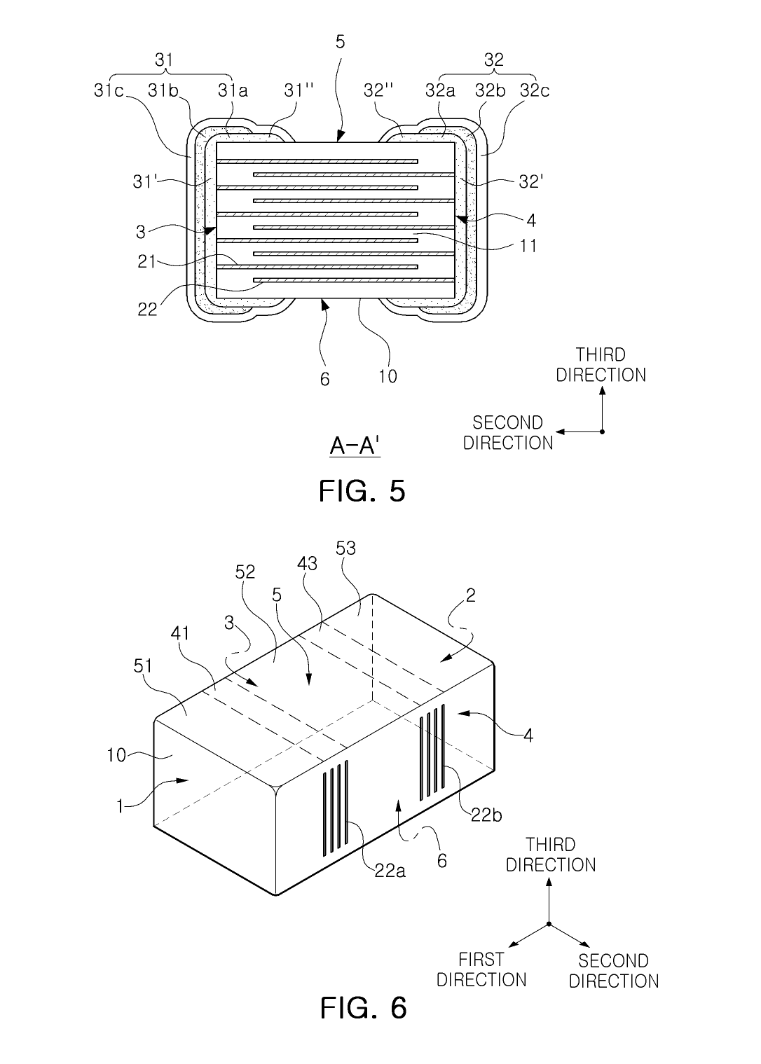

FIG. 6 is a perspective view illustrating a ceramic body and internal electrodes of a multilayer ceramic component according to another exemplary embodiment; and FIG. 7 is an exploded perspective view illustrating a multilayer structure of ceramic laminates of the multilayer ceramic component according to another exemplary embodiment.

In a description of a multilayer ceramic component according to another exemplary embodiment, a description of contents which overlap the contents of the multilayer ceramic component according to the exemplary embodiment described above will be omitted, and contents different from the contents of the multilayer ceramic component according to the exemplary embodiment described above will mainly be described.

In another exemplary embodiment, the first direction of the ceramic body 10 refers to a direction in which dielectric layers 11 and internal electrodes 21a, 22a, 21b, and 22b are stacked in the ceramic body.

Referring to FIGS. 6 and 7, each of the ceramic laminates 41 and 42 may include a plurality of dielectric layers 11. Here, first to fourth internal electrodes 21a, 22a, 21b, and 22b may be formed on each dielectric layer of the ceramic laminates 41 and 42.

In another exemplary embodiment, the ceramic laminates 41 and 42 may be disposed to be spaced apart from each other by a predetermined interval in the first direction of the ceramic body, and may include the internal electrodes 21a, 22a, 21b, and 22b alternately exposed through the third and fourth surfaces 3 and 4 of the ceramic body in the second direction thereof with each of the dielectric layers 11 interposed therebetween.

In another exemplary embodiment, each of the ceramic laminates 41 and 42 may include an active layer which contributes to forming capacitance, and upper and lower cover layers formed as upper and lower margin parts on upper and lower surfaces of the active layers, respectively. The active layer may include the dielectric layers 11 and the internal electrodes 21a, 22a, 21b, and 22b, and a plurality of first to fourth internal electrodes 21a, 22a, 21b, and 22b may be alternately formed with each of the dielectric layers 11 interposed therebetween.

In another exemplary embodiment, the upper and lower cover layers may be formed of the same material as that of the dielectric layers 11 and have the same configuration as that of the dielectric layers 11 except that they do not include the internal electrodes. The upper and lower cover layers may be formed by stacking a single dielectric layer or two or more dielectric layers on upper and lower surfaces of the active layer, respectively, in the third direction, and may serve to prevent damage to the internal electrodes due to physical or chemical stress.

In another exemplary embodiment, a buffer part 52 in which the internal electrodes are not formed may be interposed between the ceramic laminates 41 and 42, and cover parts 51 and 53 may be disposed at opposite end portions of the ceramic body in the first direction thereof, respectively. The buffer part 52 and the cover parts 51 and 53 may be formed of the same material as that of the dielectric layers 11 and have the same configuration as that of the dielectric layers 11 except that they do not include the internal electrodes.

In another exemplary embodiment, the first and second internal electrodes 21a and 22a may overlap each other to form capacitance, and the first and second external electrodes 31 and 32 may be connected to the first and second internal electrodes 21a and 22a, respectively. Likewise, the third and fourth internal electrodes 21b and 22b may overlap each other to form capacitance, and the third and fourth external electrodes 33 and 34 may be connected to the third and fourth internal electrodes 21b and 22b, respectively. Voltages having opposite polarities may be applied to the first and second internal electrodes 21a and 22a, respectively, and voltages having opposite polarities may be applied to the third and fourth internal electrodes 21b and 22b, respectively.

In another exemplary embodiment, the dielectric layers 11 may be in a sintered state, and adjacent dielectric layers may be integrated with each other so that boundaries therebetween are not readily apparent.

In another exemplary embodiment, the first to fourth internal electrodes 21a, 22a, 21b, and 22b may be electrically connected, respectively, to the first to fourth external electrodes 31 to 34 through portions thereof exposed to the third and fourth surfaces 3 and 4 of the ceramic body 10. Therefore, when voltages are applied to the first to fourth external electrodes 31 to 34, electric charges may be accumulated between the first to fourth internal electrodes 21a, 22a, 21b, and 22b facing each other. In this case, capacitance of the multilayer ceramic component 10 may be in proportion to an area of a region in which the first to fourth internal electrodes 21a, 22a, 21b, and 22b overlap each other.

Meanwhile, although a case in which the number of external electrodes is four (two pairs) has been illustrated for convenience of explanation in FIGS. 1 through 7, it is obvious to those skilled in the art that the number of external electrodes is not limited thereto, and may be increased to six or more (three or more pairs) depending on the ceramic laminates in the ceramic body.

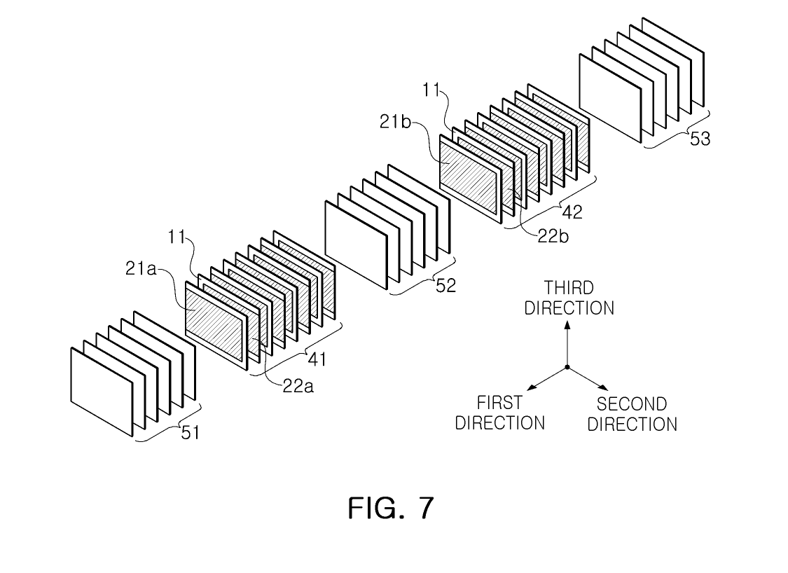

For example, as illustrated in FIG. 8, the number of external electrodes may be six (three pairs), and fifth and sixth external electrodes 35 and 36 may serve as a pair of external electrodes to which different voltages are applied, respectively, while other contents are the same as the above-mentioned contents.

Method of Manufacturing Multilayer Ceramic Component

Next, a method of manufacturing a multilayer ceramic component according to an exemplary embodiment will be described in detail. However, a method of manufacturing a multilayer ceramic component is not necessarily limited thereto.

In a description of a method of manufacturing a multilayer ceramic component according to an exemplary embodiment, a description of contents which overlap the contents of the multilayer ceramic component according to the exemplary embodiment described above will be omitted.

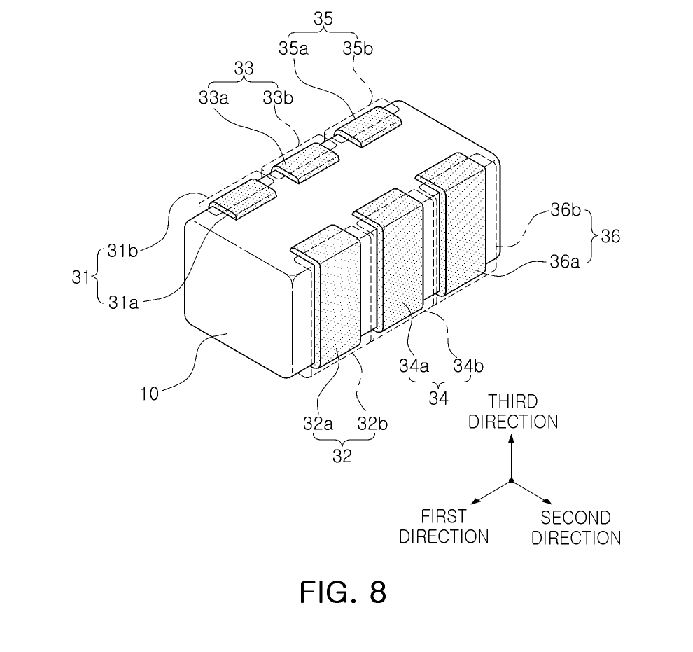

FIG. 9 is a flow chart schematically illustrating a method of manufacturing a multilayer ceramic component according to an exemplary embodiment.

Referring to FIG. 9, the method of manufacturing a multilayer ceramic component according to an exemplary embodiment may include: forming a ceramic body including a plurality of ceramic laminates, each including dielectric layers and internal electrodes (S1); forming a plurality of base electrode layers on outer surfaces of the ceramic body to be connected to the internal electrodes of the plurality of ceramic laminates (S2), respectively; and forming a plurality of resin electrode layers on the plurality of base electrode layers, respectively, to expose at least portions of end portions of the base electrode layers (S3).

In an exemplary embodiment, in the forming of the ceramic body, slurry containing powder such as barium titanate (BaTiO₃) powder, or the like, may be applied onto carrier film and be dried to prepare a plurality of ceramic green sheets, thereby forming dielectric layers and cover layers.

In an exemplary embodiment, the ceramic green sheets may be manufactured by preparing slurry by mixing ceramic powder, a binder, and a solvent with each other and manufacturing the slurry in a sheet shape having a thickness of several micrometers by a doctor blade method.

Next, conductive paste for an internal electrode containing conductive powder may be applied to the ceramic green sheets by a screen printing method to form the internal electrodes, a plurality of ceramic green sheets on which the internal electrodes are printed may be stacked, and a plurality of ceramic green sheets on which the internal electrodes are not printed may be stacked on upper and lower surfaces of a multilayer body and then be sintered to form a ceramic body.

In an exemplary embodiment, the ceramic body may include a plurality of ceramic laminates including the internal electrodes, the dielectric layers, and the cover layers, a buffer part interposed between the ceramic laminates and not having the internal electrodes, and cover parts not having the internal electrodes and disposed at opposite end portions of the ceramic body. In the ceramic laminate, the dielectric layers may be formed by sintering the ceramic green sheets on which the internal electrodes are printed, and the cover layers may be formed by sintering the ceramic green sheets on which the internal electrodes are not printed.

Next, the plurality of base electrode layers may be formed on the outer surfaces of the ceramic body to be electrically connected to the internal electrodes of the plurality of ceramic laminates, respectively.

In an exemplary embodiment, in order to form main parts, the third and fourth surfaces of the ceramic body through which the internal electrodes are exposed may be first dipped in paste for forming the base electrode layers. Then, in order to form extended parts, paste for forming the base electrode layers may be additionally applied onto the outer surfaces of the ceramic body to be connected to the paste applied for the purpose of forming the main parts, and the paste for forming the base electrode layers may be fired to form the base electrode layers. The application of the paste for forming the extended parts may be performed by printing the paste for forming the base electrode layers on the outer surfaces of the ceramic body.

In an exemplary embodiment, the base electrode layers may be formed by firing paste containing a conductive metal and glass. The conductive metal is not particularly limited, but may be, for example, one or more selected from the group consisting of copper (Cu), silver (Ag), nickel (Ni), and an alloy thereof, and may preferably be the copper (Cu) as described above. The glass is not particularly limited, but may be a material having the same composition as that of glass used to manufacture an external electrode of a multilayer ceramic component according to the related art.

Next, a resin composition may be applied onto each of the plurality of resin electrode layers disposed on the plurality of base electrode layers to expose at least portions of the end portions of the base electrode layers, and be hardened to form the resin electrode layers.

In an exemplary embodiment, the resin composition may contain conductive powder and a base resin. Here, the base resin may be an epoxy resin, which is a thermosetting resin, but is not limited thereto.

The method of manufacturing a multilayer ceramic component according to an exemplary embodiment may further include, after the forming of the plurality of resin electrode layers, forming plating layers on the resin electrode layers, if necessary. The plating layers may include nickel plating layers and tin plating layers formed on the nickel plating layers, respectively.

Circuit Board Having Multilayer Ceramic Component

According to an exemplary embodiment, a circuit board having the multilayer ceramic component described above may be provided.

In a description of a circuit board having a multilayer ceramic component according to an exemplary embodiment, a description of contents that are the same as the contents of the multilayer ceramic component according to the exemplary embodiment described above will be omitted in order to avoid an overlapping description.

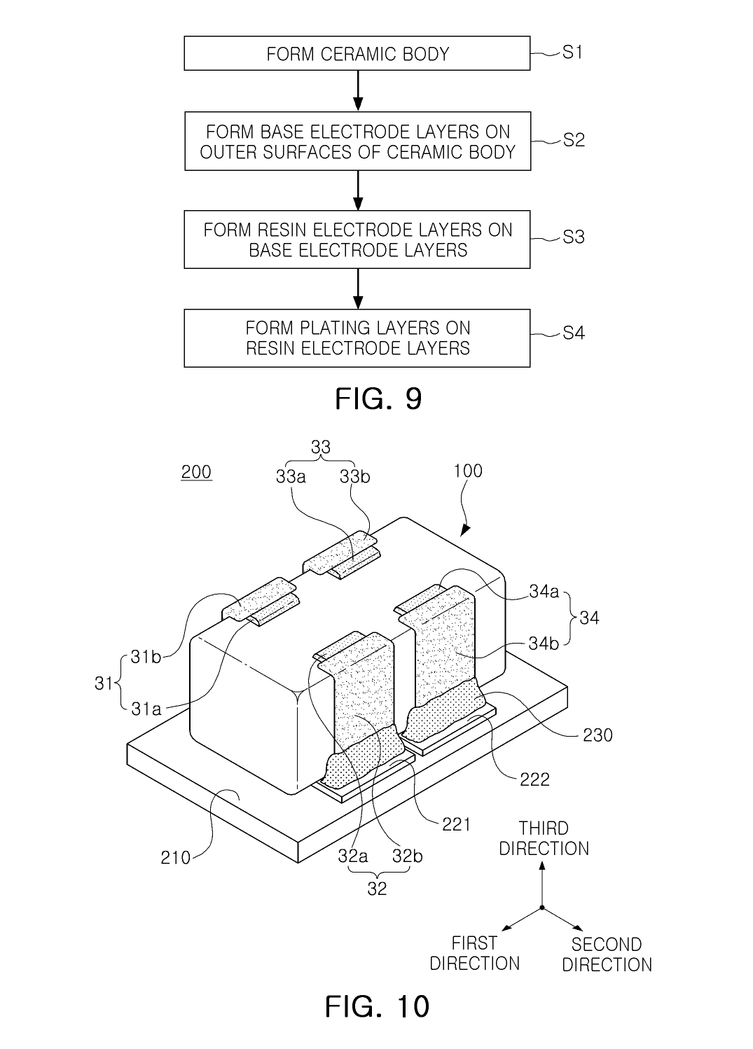

FIG. 10 is a perspective view schematically illustrating a circuit board having a multilayer ceramic component according to an exemplary embodiment.

Referring to FIG. 10, a circuit board 200 having a multilayer ceramic component 100 according to an exemplary embodiment may include a printed circuit board 210 having a plurality of electrode pads 221 and 222 disposed thereon; and the multilayer ceramic component 100 as described above installed on the printed circuit board 210.

In an exemplary embodiment, the multilayer ceramic component 100 may be electrically connected to the printed circuit board 210 by solders 230, or the like, in a state in which the external electrodes 31 to 34 are positioned on the electrode pads 221 and 222, respectively, to contact the electrode pads 221 and 222, respectively. Although not illustrated in FIG. 10, as described above, on the external electrodes, the plating layers covering the exposed end portions of the base electrode layers may be formed on the resin electrode layers.

### Experimental Example 1

An ESR defect rate of a three-terminal array type multilayer ceramic capacitor having a size of 1608 according to the present disclosure depending on a length X₂ was measured and shown in Table 1. In this measurement, Y₂ was fixed as 30 μm.

TABLE 1

| Method of Forming External | Length | ESR Defect | |
|---|---|---|---|
| Electrodes | X₂ | Rate (%) | Decision |
| Resin Electrode Layers Are Not | — | 0% | OK |
| Applied | | | |
| Resin Electrode Layers are Applied | — | 1.05% | X |
| to Cover Entire Base Electrode | | | |
| Layers | | | |
| Resin Electrode Layers are Applied | 0.5 μm | 0.97% | X |
| to Expose End Portions of Base | | | |
| Electrode Layers | | | |
| Resin Electrode Layers are Applied | 1 μm | 0% | OK |
| to Expose End Portions of Base | | | |
| Electrode Layers | | | |
| Resin Electrode Layers are Applied | 20 μm | 0% | OK |
| to Expose End Portions of Base | | | |
| Electrode Layers | | | |
| Resin Electrode Layers are Applied | 50 μm | 0% | OK |
| to Expose End Portions of Base | | | |
| Electrode Layers | | | |
| Resin Electrode Layers are Applied | 100 μm | 0% | OK |
| to Expose End Portions of Base | | | |
| Electrode Layers | | | |

As seen in Table 1, in a case in which the length X₂ was less than 1 μm, an ESR improvement effect was not present, and in a case in which the length X₂ was 1 μm or more, an ESR improvement effect occurred. However, it is preferable that terminals adjacent to each other are spaced apart from each other by approximately 10 μm in order to prevent a short circuit therebetween.

### Experimental Example 2

An ESR defect rate of a three-terminal array type multilayer ceramic capacitor having a size of 1608 according to the present disclosure depending on a length Y₂ was measured and shown in Table 2. In this measurement, X₂ was fixed as 50 μm.

TABLE 2

| Method of Forming External | Length | ESR Defect | |
|---|---|---|---|
| Electrodes | Y₂ | Rate (%) | Decision |
| Resin Electrode Layers are Not | — | 0% | OK |
| Applied | | | |
| Resin Electrode Layers are Applied | — | 1.27% | X |
| to Cover Entire Base Electrode | | | |
| Layers | | | |
| Resin Electrode Layers are Applied | 0.5 μm | 1.13% | X |
| to Expose End Portions of Base | | | |
| Electrode Layers | | | |
| Resin Electrode Layers are Applied | 1 μm | 0% | OK |
| to Expose End Portions of Base | | | |
| Electrode Layers | | | |
| Resin Electrode Layers are Applied | 10 μm | 0% | OK |
| to Expose End Portions of Base | | | |
| Electrode Layers | | | |
| Resin Electrode Layers are Applied | 30 μm | 0% | OK |
| to Expose End Portions of Base | | | |
| Electrode Layers | | | |
| Resin Electrode Layers are Applied | 50 μm | 0% | OK |
| to Expose End Portions of Base | | | |
| Electrode Layers | | | |

As seen in Table 2, in a case in which the length Y₂ was less than 1 μm, an ESR improvement effect was not present, and in a case in which the length Y₂ was 1 μm or more, an ESR improvement effect occurred. However, it is preferable that terminals facing each other are spaced apart from each other by approximately 10 μm in order to prevent a short circuit therebetween.

As set forth above, according to exemplary embodiments in the present disclosure, a multilayer ceramic component having low ESR, excellent durability and reliability, being microminiaturized, and having ultra high capacitance, and a method of manufacturing the same, may be provided.

While exemplary embodiments have been shown and described above, it will be apparent to those skilled in the art that modifications and variations could be made without departing from the scope of the present invention as defined by the appended claims.

What is claimed is:

1. A multilayer ceramic component comprising:
a ceramic body including a plurality of ceramic laminates, each including a plurality of dielectric layers and a plurality of internal electrodes, and having first and second surfaces opposing each other in a first direction, third and fourth surfaces opposing each other in a second direction, and fifth and sixth surfaces opposing each other in a third direction; and
a plurality of external electrodes including base electrode layers disposed on outer surfaces of the ceramic body and respectively connected to the internal electrodes of the ceramic laminates, and resin electrode layers disposed on the base electrode layers to expose at least portions of end portions of the base electrode layers, respectively.

2. The multilayer ceramic component of claim 1, wherein the plurality of external electrodes further include plating layers disposed on the resin electrode layers, respectively.

3. The multilayer ceramic component of claim 2, wherein the plating layers cover the exposed end portions of the base electrode layers.

4. The multilayer ceramic component of claim 1, wherein the plurality of ceramic laminates are disposed to be spaced apart from each other by a predetermined interval in the first direction of the ceramic body, and include the internal electrodes alternately exposed through the third and fourth surfaces of the ceramic body in the second direction with respective dielectric layers interposed between the internal electrodes.

5. The multilayer ceramic component of claim 4, wherein the plurality of external electrodes are connected, respectively, to the internal electrodes of the plurality of ceramic laminates exposed through the third and fourth surfaces of the ceramic body in the second direction thereof.

6. The multilayer ceramic component of claim 4, wherein the base electrode layers include main parts formed on the third and fourth surfaces of the ceramic body in the second direction thereof and connected to the internal electrodes of the ceramic laminates and extended parts extended from the main parts and formed on the fifth and sixth surfaces of the ceramic body in the third direction thereof, respectively.

7. The multilayer ceramic component of claim 6, wherein the resin electrode layers cover portions of the extended parts of the base electrode layers.

8. The multilayer ceramic component of claim 6, wherein the resin electrode layers cover the entire main parts of the base electrode layers.

9. The multilayer ceramic component of claim 1, wherein a length of each of the exposed end portions of the base electrode layers in the first direction of the ceramic body is 1 μm or more.

10. The multilayer ceramic component of claim 9, wherein a distance between the base electrode layers adjacent to each other in the first direction of the ceramic body is 10 μm or more.

11. The multilayer ceramic component of claim 1, wherein a length of each of the exposed end portions of the base electrode layers in the second direction of the ceramic body is 1 μm or more.

12. The multilayer ceramic component of claim 11, wherein a distance between the base electrode layers facing each other in the second direction of the ceramic body is 10 μm or more.

13. The multilayer ceramic component of claim 1, wherein the base electrode layers are firing-type electrodes.

14. The multilayer ceramic component of claim 1, wherein the resin electrode layers contain conductive particles and a thermosetting polymer.

15. A multilayer ceramic component comprising:
a ceramic body including a plurality of ceramic laminates, each including a plurality of dielectric layers and a plurality of internal electrodes; and
a plurality of external electrodes including base electrode layers disposed on outer surfaces of the ceramic body and respectively connected to the internal electrodes of the ceramic laminates, resin electrode layers disposed on the base electrode layers, and plating layers disposed on the resin electrode layers, respectively,
wherein the base electrode layers have end portions exposed from the resin electrode layers and directly contact the plating layers through the end portions.

16. A multilayer ceramic component comprising:
a ceramic body having first and second surfaces opposing each other, third and fourth surfaces opposing each other, and fifth and sixth surfaces opposing each other, and including a plurality of ceramic laminates, each ceramic laminate including a plurality of dielectric layers and a plurality of internal electrodes alternatively exposed to the third and fourth surfaces of the ceramic body; and
a plurality of external electrodes including base electrode layers including end portions disposed on the fifth and sixth surfaces of the ceramic body and extending between the end portions to electrically connect to the internal electrodes exposed to the third and fourth surfaces of the ceramic body, respectively, and resin electrode layers disposed on the base electrode layers to expose portions of the end portions of the base electrode layers, respectively.

17. The multilayer ceramic component of claim 16, wherein the resin electrode layers completely cover any portions of the base electrode layers that are formed on the third and fourth surfaces, respectively.

18. The multilayer ceramic component of claim 16, wherein the plurality of external electrodes further include plating layers disposed on the resin electrode layers, respectively, and the resin electrode layers are respectively interposed between the plating layers and the base electrode layers.

19. The multilayer ceramic component of claim 18, wherein the plating layers directly contact the exposed portions of the base electrode layers exposed from the resin electrode layers.

20. The multilayer ceramic component of claim 16, wherein a conductivity of the resin electrode layers is less than that of the base electrode layers.
